(19) United States
(12) Patent Application Publication
(10) Pub. No.: US 2026/0127308 A1
(43) Pub. Date: May 7, 2026

(54) A SYSTEM THAT MANAGES ACCOUNTS BASED ON ACCESS POLICIES ESTABLISHED THROUGH ONTOLOGY NEURAL NETWORKS

(71) Applicant: SGA Solutions Co.,Ltd., Uiwang-si (KR)

(72) Inventor: Ja Il KOO, II, Anyang-si (KR)

(21) Appl. No.: 19/372,823

(22) Filed: Oct. 29, 2025

(30) Foreign Application Priority Data
Nov. 5, 2024 (KR) 10-2024-0155550

(51) Int. Cl. G06F 21/62

(52) U.S. Cl. CPC G06F 21/6218

(57) ABSTRACT

The computing device-implemented system for managing enterprise account access based on policies established through an ontology artificial intelligence algorithm, implemented by a computing device including one or more processors and one or more memories storing instructions. The system comprises a Work Attribute Information Analysis Unit configured to analyze enterprise work attribute information using the stored ontology AI algorithm when an access policy update is initiated. An Access Policy Establishment Unit utilizes these analysis results to update the existing access policy, thereby establishing a precise new access policy for managed resource information. An Account Access Management Unit enforces this new policy by analyzing an accessing member account's attributes against the new policy to determine whether to permit or deny access to specific resource information. This approach ensures dynamically established, context-aware access control tailored to evolving enterprise work attributes.

### FIELD OF THE INVENTION

The present invention relates to a system that manages accounts based on access policies established through an ontology neural network. More particularly, when an update process for updating an enterprise access policy is initiated, a stored ontology artificial intelligence algorithm analyzes a plurality of pieces of work attribute information to update an existing access policy for resource information managed by the enterprise and to establish a new access policy. When a member account accessing particular resource information stored in a resource database managed by the enterprise is identified, the system analyzes member attribute information of the identified member account and the established new access policy to determine whether the member account is permitted to access the particular resource information, thereby deciding whether to grant the member account access to the particular resource information.

### BACKGROUND OF THE INVENTION

Information security technology protects critical information such as enterprise confidential information, customer information, and intellectual property, and provides technologies and services to prevent security threats such as cyber-attacks, insider leaks, and data breaches. In particular, enterprises actively adopt information security technologies and minimize the risk of internal data leakage by regulating methods and privileges for accessing enterprise networks and systems through strict access policies and naming rules. However, recently, issues have been pointed out that overly strict enterprise access policies degrade work efficiency, and that managing the enterprise access policies requires significant cost and time.

Accordingly, the industry has developed various technologies to address the above problems. For example, Korean Registered Patent No. 10-2640648 (“Enterprise Asset Management System Through Specialized Database Establishment”) discloses technology for establishing a specialized database to identify threat behaviors against assets within an enterprise.

However, the above prior art merely discloses technology that detects threat behavior by analyzing network packets, extracts threat behaviors corresponding to preset threat behavior classifications, and merges extracted threat behavior data according to predefined purposes to build a database. It does not disclose technology which, when an update process for updating enterprise access policies is initiated, uses a stored ontology artificial intelligence algorithm to analyze a plurality of pieces of work attribute information, updates an existing access policy for resource information managed by the enterprise to establish a new access policy, and, when a member account that accesses particular resource information stored in a resource database managed by the enterprise is identified, analyzes member attribute information of the identified member account and the established new access policy to determine whether the member account can access the particular resource information, thereby deciding whether to grant access to the particular resource information. A technology that can solve this is therefore needed.

### SUMMARY OF THE INVENTION

To overcome the problems of the related art, the invention provides a system which, when an update process for updating enterprise access policies is initiated, uses a stored ontology artificial intelligence algorithm to analyze a plurality of pieces of work attribute information, updates an existing access policy for resource information managed by the enterprise to establish a new access policy, and, when a member account that accesses particular resource information stored in a resource database managed by the enterprise is identified, analyzes member attribute information of the identified member account and the established new access policy to determine whether the member account can access the particular resource information, thereby deciding whether to grant access. Thus, based on work attribute information exchanged in accordance with internal circumstances and market conditions, access policies for enterprise-managed resource information can be flexibly revised and managed to improve members'work efficiency while saving cost and time consumed in managing access policies.

According to an embodiment, there is provided a system for managing accounts based on access policies established through an ontology artificial intelligence algorithm, the system being implemented by a computing device including one or more processors and one or more memories storing instructions executable by the processors. The system comprises: a work attribute information analysis unit configured to, when an update process for updating enterprise access policies is initiated through a plurality of pieces of work attribute information stored in a work database managed by an enterprise, analyze the plurality of pieces of work attribute information using a stored ontology artificial intelligence algorithm; an access policy establishment unit configured to, upon completion of functions of the work attribute information analysis unit, update an existing access policy for resource information managed by the enterprise based on results of analyzing the plurality of pieces of work attribute information using the stored ontology artificial intelligence algorithm to establish a new access policy; and an account access management unit configured to, when, in a state where the new access policy has been established, a first member account that accesses first resource information among a plurality of pieces of resource information stored in a resource database managed by the enterprise is identified, analyze member attribute information registered to the first member account and the new access policy to determine whether the first member account can access the first resource information and, based on a determination result, decide whether to permit the first member account to access the first resource information.

According to the system for managing accounts based on access policies established through an ontology neural network, work attribute information is analyzed using a stored ontology artificial intelligence algorithm. In accordance with internal atmosphere and internal work progress, permission of member accounts to access particular resource information can be variably and finely updated to establish a new access policy. As the permission of member accounts to access particular resource information is finely updated and a new access policy is established, access rights to the particular resource information can be flexibly updated per member, thereby improving member work efficiency and saving time and costs for managing access policies from the enterprise perspective.

### BRIEF DESCRIPTION OF THE DRAWINGS

FIG. 1 is a block diagram for explaining a system that manages accounts based on access policies established through an ontology neural network according to an embodiment of the present invention.

FIG. 2 is a block diagram for explaining a work attribute information analysis unit of the system according to an embodiment.

FIG. 3 is a block diagram for explaining an access policy establishment unit of the system according to an embodiment.

FIG. 4 is another block diagram for explaining the access policy establishment unit of the system according to an embodiment.

FIG. 5 is a block diagram for explaining an account access management unit of the system according to an embodiment.

FIG. 6 illustrates an example of an internal configuration of a computing device according to an embodiment.

### DETAILED DESCRIPTION OF THE INVENTION

Hereinafter, various embodiments and/or aspects are disclosed with reference to the drawings. In the following description, for purposes of explanation, numerous specific details are set forth to aid an overall understanding of one or more aspects. However, it will also be recognized by those of ordinary skill in the art that these aspects can be practiced without such specific details. The following description and the accompanying drawings describe specific exemplary aspects of one or more aspects in detail. However, these aspects are illustrative, some among various methods within the principles of the aspects may be used, and the described explanations are intended to encompass such aspects and their equivalents.

As used in this specification, terms such as “embodiment,” “example,” “aspect,” and “illustrative” do not necessarily mean that the described aspect or design is superior to, or has advantages over, other aspects or designs.

Further, the terms “includes” and/or “including” signify the presence of the corresponding feature and/or component, but are to be understood as not excluding the presence or addition of one or more other features, components, and/or groups thereof.

Moreover, ordinal terms such as first and second may be used to describe various components, but the components are not limited by such terms. The terms are used only for the purpose of distinguishing one component from another. For example, without departing from the scope of the present invention, a first component may be designated as a second component, and similarly a second component may be designated as a first component. The expression “and/or”means any combination of, or any one among, a plurality of related stated items.

Unless otherwise defined, in the embodiments of the present invention, all terms used herein, including technical or scientific terms, have the same meanings as commonly understood by those skilled in the art to which the present invention pertains. Terms defined in commonly used dictionaries should be interpreted as having meanings consistent with the context of the related art, and, unless explicitly defined in the embodiments of the present invention, should not be interpreted as having idealized or overly formal meanings.

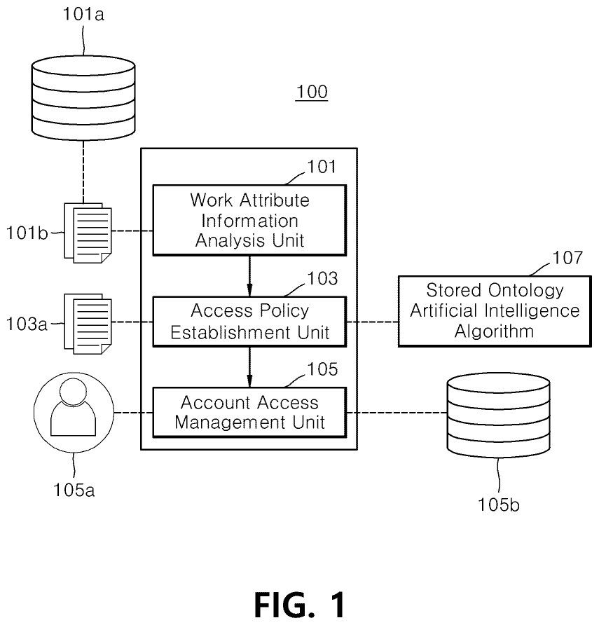

FIG. 1 is a block diagram for explaining a system for managing accounts based on access policies established through an ontology neural network according to an embodiment of the present invention.

Referring to FIG. 1, a system (100) for managing accounts based on access policies established through an ontology neural network, implemented by a computing device including one or more processors and one or more memories storing instructions executable by the processors, may include a work attribute information analysis unit 101, an access policy establishment unit 103, and an account access management unit 105.

In one embodiment, when an update process for updating enterprise access policies is initiated through a plurality of pieces of work attribute information 101b stored in a work database 101a managed by the enterprise, the work attribute information analysis unit 101 may analyze the plurality of pieces of work attribute information 101b by using a stored ontology artificial intelligence algorithm 107.

In one embodiment, the plurality of pieces of work attribute information 101b are information including intra-company bylaw information, email information of members within the enterprise (including email contents, email recipients, and email senders), messenger information of members within the enterprise (including messenger contents, messenger recipients, and messenger senders), and existing access policy information for enterprise resource information (e.g., human resource information, physical resource information, financial resource information, information resource information, supply-chain resource information, knowledge resource information, etc.), and the plurality of pieces of work attribute information 101b may be stored in the work database 101a.

In one embodiment, the work attribute information analysis unit 101, when the update process is initiated, may analyze the plurality of pieces of work attribute information 101b by using the stored ontology artificial intelligence algorithm 107.

In one embodiment, the stored ontology artificial intelligence algorithm 107 is an algorithm combining ontology and a neural network and may be used in machine learning and natural language processing. Ontology defines concepts and relationships between concepts, thereby enabling effective processing and analysis of data, and such an ontology neural network may be an artificial intelligence algorithm used to learn patterns and to perform prediction from input data.

In one embodiment, the stored ontology artificial intelligence algorithm 107 may include at least one of a deep-learning-based ontology learning model, a Transformer-based ontology learning model, a rule-based ontology learning model, a hybrid ontology learning model, and an ontology reasoning model.

In relation thereto, the deep-learning-based ontology learning model is a model that learns ontology by using deep learning and may typically include Word2Vec, GloVe, and FastText.

Further, a Transformer-based ontology learning model is a model capable of fast and accurate learning by processing input data in parallel, and may include BERT and GPT.

Additionally, a rule-based ontology learning model is a model that learns ontology by using rules and may be a model useful for constructing ontology by utilizing expert knowledge.

In addition, a hybrid ontology learning model is a model combining deep learning and rule-based learning to complement limitations of deep learning and to construct a more accurate ontology.

Lastly, an ontology reasoning model is a model that performs reasoning by using ontology and may be a model that analyzes given data and, on that basis, generates or predicts new information.

Accordingly, when the update process is initiated, the work attribute information analysis unit 101 may analyze the plurality of pieces of work attribute information 101b by using the stored ontology artificial intelligence algorithm 107 in order to modify existing access policies for resource information managed by the enterprise into new policies. More specifically, when the update process is initiated, the work attribute information analysis unit 101 may identify sentences corresponding to detail information included in each of the plurality of pieces of work attribute information 101b.

Thereafter, in order to identify, among the keywords included in the sentence, a subject keyword, an object keyword, and a predicate keyword, the work attribute information analysis unit 101 may perform a syntactic parsing process for identifying the sentence structure of the identified sentence and identify the sentence structure. A sentence structure is a grammatical structure indicating the arrangement and relations of elements constituting a sentence and may generally be a structure composed of types such as a first, second, third, fourth, and fifth type.

In one embodiment, upon completion of the functions of the work attribute information analysis unit 101, the access policy establishment unit 103 may, based on results of analyzing the plurality of pieces of work attribute information 101b by using the stored ontology artificial intelligence algorithm 107, update an existing access policy for resource information managed by the enterprise to establish a new access policy.

In one embodiment, the access policy establishment unit 103 may, based on results of analyzing the plurality of pieces of work attribute information 101b by using the stored ontology artificial intelligence algorithm 107, update an existing access policy for resource information managed by the enterprise.

More specifically, upon completion of identification of the sentences corresponding to the detail information included in the plurality of pieces of work attribute information 101b and of the sentence structures by the functions of the work attribute information analysis unit 101, the access policy establishment unit 103 may analyze the sentences by using the stored ontology artificial intelligence algorithm 107 and identify, for each keyword constituting the sentences, semantic attribute tags.

In relation thereto, the semantic attribute tag is a tag value for identifying the meaning (or concept) of a keyword and may include, for example, a member tag for identifying a member in a sentence, a rank tag for identifying a job grade in a sentence, a task tag for identifying a task in a sentence, and a permission tag for identifying an authority in a sentence.

Accordingly, the access policy establishment unit 103 may analyze, by using the stored ontology artificial intelligence algorithm 107, the sentences corresponding to the detail information included in the plurality of pieces of work attribute information 101b, identify semantic attribute tags for respective sentences corresponding to work attribute information excluding the existing access policy information and for sentences corresponding to the existing access policy information, and, on the basis of the identified semantic attribute tags, update an existing access policy sentence into a new access policy sentence.

In relation thereto, the access policy establishment unit 103 may generate new access policy information 103a through the new access policy sentence and store the generated new access policy information 103a in an access policy repository so as to complete establishment of the new access policy.

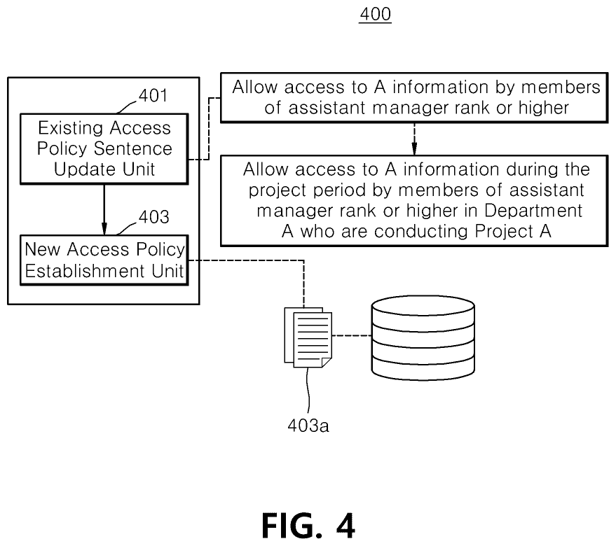

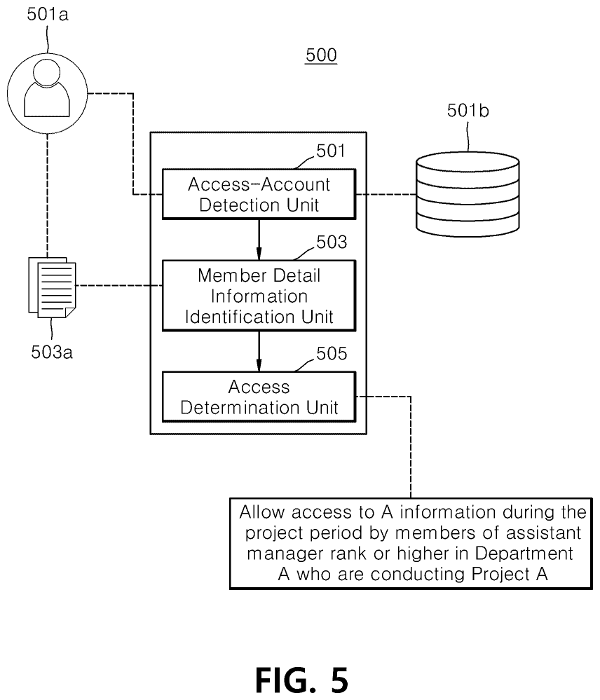

In one embodiment, detailed explanations of the access policy establishment unit 103 updating the existing access policy sentence into the new access policy sentence to establish the new access policy will be described with reference to FIGS. 4 to 5.

In one embodiment, the account access management unit 105, in a state where establishment of the new access policy has been completed, when a first member account 105a accessing first resource information among a plurality of pieces of resource information stored in a resource database 105b managed by the enterprise is identified, may analyze member attribute information registered to the first member account 105a and the new access policy to determine whether the first member account can access the first resource information and, on the basis of the determination result, decide whether to permit access of the first member account to the first resource information.

In one embodiment, the member attribute information may be information including a member name within the enterprise, member age group, member gender, member residence, member affiliated department, member rank, member rank privilege, member assigned work, member task, and assigned project.

In one embodiment, the account access management unit 105 may monitor, in real time, a member account among a plurality of member accounts that attempts to access the resource database 105b.

Accordingly, when the account access management unit 105 identifies the first member account 105a accessing the first resource information among the plurality of pieces of resource information stored in the resource database 105b, the account access management unit 105 may identify, through the member attribute information registered to the first member account 105a, the name, age group, gender, residence, affiliated department, rank, rank privilege, assigned work, task, and assigned project of the user of the first member account. Thereafter, the account access management unit 105 may compare the new access policy sentence based on the new access policy with the identified member attribute information of the first member account 105a and determine whether the first member account 105a can access the first resource information.

In relation thereto, the account access management unit 105 may, on the basis of the determination result, decide whether to permit the first member account 105a to access the first resource information.

The present invention aims to flexibly update, in detail (e.g., by time zone, by project, by privilege, etc.), whether a member account is permitted to access particular resource information according to the internal atmosphere and internal work progress by using work attribute information, thereby saving time and cost for managing access policies as well as improving work efficiency of members.

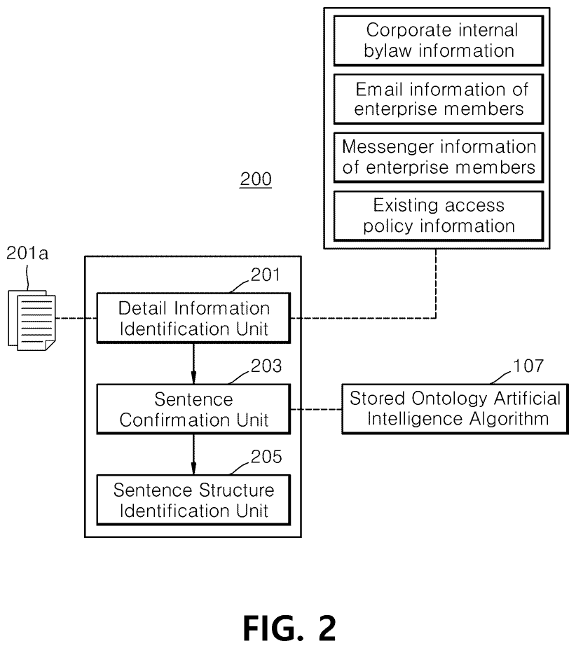

FIG. 2 is a block diagram for explaining a work attribute information analysis unit of a system for managing accounts based on access policies established through an ontology neural network according to an embodiment of the present invention. Referring to FIG. 2, a system (e.g., the system (100) of FIG. 1) for managing accounts based on access policies established through an ontology neural network, implemented by a computing device including one or more processors and one or more memories storing instructions executable by the processors, may include a work attribute information analysis unit 200 (e.g., the work attribute information analysis unit 101 of FIG. 1).

In one embodiment, when an update process for updating enterprise access policies is initiated through a plurality of pieces of work attribute information 201a stored in a work database managed by the enterprise, the work attribute information analysis unit 200 may analyze the plurality of pieces of work attribute information 201a by using a stored ontology artificial intelligence algorithm.

In one embodiment, as detailed components for performing the above-described function, the work attribute information analysis unit 200 may include a detail information identification unit 201, a sentence confirmation unit 203, and a sentence structure identification unit 205.

In one embodiment, when the update process is initiated, the detail information identification unit 201 may identify detail information included in each of the plurality of pieces of work attribute information 201a stored in the work database.

In one embodiment, when the update process is initiated, the detail information identification unit 201 may identify, as the detail information included in the plurality of pieces of work attribute information 201a, intra-company bylaw information, email information of members within the enterprise, messenger information of members within the enterprise, and existing access policy information for enterprise resource information.

In one embodiment, upon completion of the function of the detail information identification unit 201, the sentence confirmation unit 203 may perform natural language processing on the identified detail information by using the stored ontology artificial intelligence algorithm and may confirm sentences corresponding to the detail information.

In one embodiment, the sentence confirmation unit 203 may, by using the stored ontology artificial intelligence algorithm, perform natural language processing on the detail information included in the plurality of pieces of work attribute information and confirm sentences corresponding to the detail information.

In one embodiment, upon completion of the function of the sentence confirmation unit 203, the sentence structure identification unit 205 may start a syntactic parsing process on the confirmed sentences by using the stored ontology artificial intelligence algorithm and may identify the sentence structures.

More specifically, the sentence structure identification unit 205 may, by using the stored ontology artificial intelligence algorithm, start a syntactic parsing process on the confirmed sentences, recognize a plurality of morphemes included in the sentences and types of the morphemes, and, by classifying the types of the morphemes, recognize the combination of an independent morpheme and a dependent morpheme as one token and designate it as one word segment.

In relation thereto, upon completion of confirmation of the plurality of word segment included in the sentence, the sentence structure identification unit 205 may, on the basis of stored part-of-speech classification information reflected in the stored ontology artificial intelligence algorithm, confirm parts of speech of the morphemes included in the plurality of word segment and identify sentence constituents for each of the plurality of word segment.

In one embodiment, the sentence structure identification unit 205 may confirm the parts of speech for each of the morphemes included in the plurality of word segment on the basis of the stored part-of-speech classification information and, through the confirmed parts of speech, classify sentence constituents of the plurality of word segment. Here, the stored part-of-speech classification information may signify part-of-speech tag information.

In one embodiment, the sentence structure identification unit 205 may define parts of speech for each morpheme through the stored part-of-speech classification information. Korean can define parts of speech for each morpheme through 5-word 9-part-of-speech tagging (part-of-speech tagging). The stored part-of-speech classification information may include reference morpheme information (including part-of-speech information) as a basis for defining parts of speech for each morpheme.

More specifically, the sentence structure identification unit 205 may define parts of speech for each morpheme through the stored part-of-speech classification information and, among morphemes whose parts of speech have been defined, determine the sentence constituent that is recognized as one token. For example, the processor may classify, on the basis of the stored part-of-speech classification information, parts of speech for “task” and “˜is”. The sentence structure identification unit 205 may classify “task” as a noun and “˜is” as a particle. The processor may, on the basis of the classified parts of speech, determine the sentence constituent of “task is,”recognized as one token, as an object.

In one embodiment, upon completion of classification of sentence constituents for the plurality of word segment included in the sentence, the sentence structure identification unit 205 may confirm combination relationships among the classified sentence constituents and determine the sentence structure for the sentence.

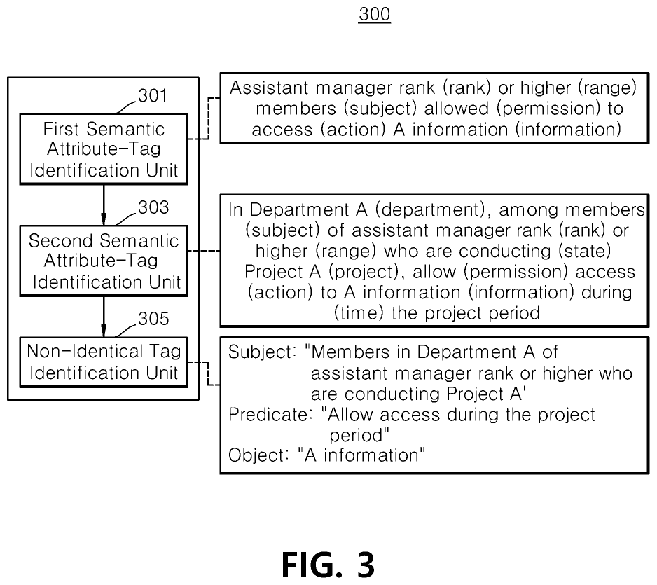

FIG. 3 is a block diagram for explaining an access policy establishment unit of a system for managing accounts based on access policies established through an ontology neural network according to an embodiment of the present invention.

Referring to FIG. 3, a system (e.g., the system (100) of FIG. 1) for managing accounts based on access policies established through an ontology neural network, implemented by a computing device including one or more processors and one or more memories storing instructions executable by the processors, may include an access policy establishment unit 300 (e.g., the access policy establishment unit 103 of FIG. 1).

In one embodiment, upon completion of the functions of the work attribute information analysis unit (e.g., the work attribute information analysis unit 101 of FIG. 1), the access policy establishment unit 300 may, based on results of analyzing the plurality of pieces of work attribute information by using the stored ontology artificial intelligence algorithm, update an existing access policy for resource information managed by the enterprise to establish a new access policy.

In one embodiment, as detailed components for performing the above-described function, the access policy establishment unit 300 may include a first semantic attribute-tag identification unit 301, a second semantic attribute-tag identification unit 303, and a non-identical tag identification unit 305.

In one embodiment, upon completion of the functions of the work attribute information analysis unit, the first semantic attribute-tag identification unit 301 may identify, for each keyword constituting an existing access policy sentence corresponding to existing access policy information among the detail information included in the plurality of pieces of work attribute information, a first semantic attribute tag.

In one embodiment, upon completion of the functions of the work attribute information analysis unit, the first semantic attribute-tag identification unit 301 may identify, by using the stored ontology artificial intelligence algorithm, keywords (word segment) constituting the existing access policy sentence that is a sentence corresponding to the existing access policy information, and may identify, for each of the identified keywords, a first semantic attribute tag.

Here, the reason why the sentence structure is identified in advance by the functions of the sentence structure identification unit 205 is that, depending on the sentence structure, even the same word may have a different meaning when interpreted in the sentence as a whole.

For example, the first semantic attribute-tag identification unit 301 may identify, by using the stored ontology artificial intelligence algorithm, the keywords (word segment) constituting the existing access policy sentence corresponding to the existing access policy information, namely, the sentence “Allow access to A information by members of assistant-manager rank or higher,” as “assistant-manager rank,” “or higher,” “member,” “A information,” “access,” and “allow.”

Accordingly, the first semantic attribute-tag identification unit 301 may identify, by using the stored ontology artificial intelligence algorithm, semantic attribute tags for the identified keywords, namely, a rank tag for the keyword “assistant-manager rank,” a range tag for the keyword “or higher,” a subject tag for the keyword “member,” an information tag for the keyword “A information,” an action tag for the keyword “access,” and a permission tag for the keyword “allow,” thereby completing identification of first semantic attribute tags for the keywords constituting the existing access policy sentence.

In one embodiment, while the first semantic attribute-tag identification unit 301 operates, the second semantic attribute-tag identification unit 303 may identify, for each keyword constituting a work attribute sentence corresponding to information other than the existing access policy information, a second semantic attribute tag.

For example, the second semantic attribute-tag identification unit 303 may identify, by using the stored ontology artificial intelligence algorithm, keywords constituting a sentence corresponding to one of the pieces of information other than the existing access policy information, namely, email information and messenger information, i.e., the sentence “In Department A, among members of assistant-manager rank or higher who are conducting Project A, allow access to A information during the project period,” as “Department A,” “assistant-manager rank,” “or higher,” “member,” “Project A,” “conduct,” “member,” “A information,” “access,” “during the project period,” and “allow.”

Accordingly, the second semantic attribute-tag identification unit 303 may identify, by using the stored ontology artificial intelligence algorithm, semantic attribute tags for the identified keywords, namely, a department tag for the keyword “Department A,” a rank tag for the keyword “assistant-manager rank,” a range tag for the keyword “or higher,” a subject tag for the keyword “member,” a project tag for the keyword “Project A,” a state tag for the keyword “conduct,” a subject tag for the keyword “member,” an information tag for the keyword “A information,” an action tag for the keyword “access,” a time tag for the keyword “during the project period,” and a permission tag for the keyword “allow,” thereby completing identification of second semantic attribute tags for the keywords constituting the sentences corresponding to the information other than the existing access policy sentence among the detail information included in the plurality of pieces of work attribute information.

In one embodiment, upon completion of identification of the first and second semantic attribute tags, the non-identical tag identification unit 305 may analyze the first and second semantic attribute tags by using the stored ontology artificial intelligence algorithm and identify a second semantic attribute tag that is non-identical to the first semantic attribute tag, and may identify, on the basis of a preset RDF-Triple structure, a second semantic attribute tag that is non-identical to the first semantic attribute tag.

In one embodiment, the non-identical tag identification unit 305 may analyze the first and second semantic attribute tags by using the stored ontology artificial intelligence algorithm and identify a second semantic attribute tag that is non-identical to the first semantic attribute tag.

Here, when identifying a second semantic attribute tag that is non-identical to the first semantic attribute tag, the non-identical tag identification unit 305 may identify department tag (Department A), project tag (Project A), and time tag (during the Project A period) as second semantic attribute tags that are non-identical to the first semantic attribute tags.

Thereafter, on the basis of the non-identical keywords, the non-identical tag identification unit 305 may, on the basis of the preset RDF-Triple structure, identify an entity keyword “members in Department A of assistant-manager rank or higher who are conducting Project A,” a predicate keyword “allow access during the project period,” and an object keyword “A information.”

More specifically, when the second semantic attribute tags that are non-identical to the first semantic attribute tags are identified as the department tag (Department A), the project tag (Project A), and the time tag (during the Project A period), the non-identical tag identification unit 305 may, when the entity keyword is “Department A,” identify the predicate keyword as “members of assistant-manager rank or higher who are conducting Project A,” and may identify the object keyword as “A information.”

Also, when the entity keyword is “Project A,” the non-identical tag identification unit 305 may identify the predicate keyword as “during the project period” and identify the object keyword as “allow access.”

Lastly, when the entity keyword is “conducting,” the non-identical tag identification unit 305 may identify the predicate keyword as “during the project period” and identify the object keyword as “allow access.”

FIG. 4 is another block diagram for explaining an access policy establishment unit of a system for managing accounts based on access policies established through an ontology neural network according to an embodiment of the present invention.

Referring to FIG. 4, a system (e.g., the system (100) of FIG. 1) for managing accounts based on access policies established through an ontology neural network, implemented by a computing device including one or more processors and one or more memories storing instructions executable by the processors, may include an access policy establishment unit 400 (e.g., the access policy establishment unit 103 of FIG. 1).

In one embodiment, upon completion of the functions of the work attribute information analysis unit (e.g., the work attribute information analysis unit 101 of FIG. 1), the access policy establishment unit 400 may, based on results of analyzing the plurality of pieces of work attribute information by using the stored ontology artificial intelligence algorithm, update an existing access policy for resource information managed by the enterprise to establish a new access policy.

In one embodiment, as detailed components for performing the above-described function, the access policy establishment unit 400 may include an existing access policy sentence update unit 401 and a new access policy establishment unit 403.

In one embodiment, upon completion of the functions of the non-identical tag identification unit (e.g., the non-identical tag identification unit 305 of FIG. 3), the existing access policy sentence update unit 401 may, on the basis of the keyword to which a second semantic attribute tag different from the first semantic attribute tag is matched, modify the existing access policy sentence and update the existing access policy sentence into a new access policy sentence on the basis of a pattern value of the stored ontology artificial intelligence algorithm.

In one embodiment, by the function of the non-identical tag identification unit, the existing access policy sentence update unit 401 may complete identification, on the basis of the preset RDF-Triple structure, of the entity keyword “members of assistant-manager rank or higher in Department A who are conducting Project A,” the predicate keyword “allow access during the project period,” and the object keyword “A information,” where the second semantic attribute tags different from the first semantic attribute tags are the department tag (Department A), the project tag (Project A), and the time tag (during the Project A period).

In one embodiment, upon completion of identification of the keywords on the basis of the RDF-Triple structure, the existing access policy sentence update unit 401 may process the identified keywords into one sentence on the basis of the preset RDF-Triple structure. More specifically, the existing access policy sentence update unit 401 may, on the basis of the preset RDF-Triple structure, update the existing access policy sentence “Allow access to A information by members of assistant-manager rank or higher” into a new access policy sentence “In Department A, among members of assistant-manager rank or higher who are conducting Project A, allow access to A information during the project period.”

That is, the existing access policy sentence update unit 401 may modify the existing access policy based on work attribute information in a detailed manner (e.g., access during a specific time, access during a specific project period, access by a member having a specific privilege during a specific time) into a new access policy sentence.

At this time, the new access policy sentence may be updated by the stored ontology artificial intelligence algorithm that includes a pattern value derived on the basis of definitions of concepts and attributes of keywords included in the sentence corresponding to the detail information contained in the work attribute information and relationships defined among them.

In relation thereto, the stored ontology neural network algorithm may be an algorithm that learns a pattern value derived by analyzing, on a timestamp-based session basis, correlations among a plurality of pieces of work attribute information managed by other enterprises, relationship information among semantic attribute tags matched to keywords included in sentences corresponding to the plurality of pieces of work attribute information managed by other enterprises, existing access policy information for asset information managed by other enterprises, and new access policy information for the asset information managed by other enterprises.

In one embodiment, upon completion of the function of the existing access policy sentence update unit 401, the new access policy establishment unit 403 may generate new access policy information 403a on the basis of the updated new access policy sentence and store the new access policy information 403a in an access policy repository managed by the enterprise, thereby completing establishment of the new access policy.

In relation thereto, the access policy repository is a repository in which access policy information is stored for distributing policies for asset information managed by the enterprise, and the new access policy establishment unit 403 may store the new access policy information 403a in the access policy repository to modify existing access policy information into the new access policy information 403a.

FIG. 5 is a block diagram for explaining an account access management unit of a system for managing accounts based on access policies established through an ontology neural network according to an embodiment of the present invention.

Referring to FIG. 5, a system (e.g., the system (100) of FIG. 1) for managing accounts based on access policies established through an ontology neural network, implemented by a computing device including one or more processors and one or more memories storing instructions executable by the processors, may include an account access management unit 500 (e.g., the account access management unit 105 of FIG. 1).

In one embodiment, in a state where establishment of the new access policy has been completed, when a first member account 501a accessing first resource information among a plurality of pieces of resource information stored in a resource database 501b managed by the enterprise is identified, the account access management unit 500 may analyze member attribute information 503a registered to the first member account and the new access policy to determine whether the first member account 501a can access the first resource information and, on the basis of the determination result, decide whether to permit the first member account 501a to access the first resource information.

In one embodiment, as detailed components for performing the above-described function, the account access management unit 500 may include an access account detection unit 501, a member detail information identification unit 503, and an access determination unit 505.

In one embodiment, in a state where establishment of the new access policy has been completed, the access account detection unit 501 may detect a first member account 501a that accesses first resource information among a plurality of pieces of resource information stored in the resource database 501b managed by the enterprise.

In one embodiment, the access account detection unit 501 may be a configuration that monitors whether there exists a member account that accesses at least one among the plurality of pieces of resource information stored in the resource database 501b.

In one embodiment, upon completion of detection of the first member account 501a accessing the first resource information, the member detail information identification unit 503 may identify detail information included in the member attribute information 503a registered to the first member account 501a.

In relation thereto, the member attribute information 503a may be information including, as detail information, a member name within the enterprise, member age group, member gender, member residence, member affiliated department, member rank, member rank privilege, member assigned work, member task, and assigned project.

In one embodiment, upon completion of identification of the detail information included in the member attribute information 503a, the access determination unit 505 may compare the new access policy information and the identified detail information included in the member attribute information and determine, based on a sentence defined by the new access policy information, whether the first member account can access the first resource information. In one embodiment, the access determination unit 505 may confirm whether the detail information included in the identified member attribute information 503a satisfies the new access policy sentence based on the new access policy information.

For example, through the detail information included in the member attribute information 503a, the access determination unit 505 may compare whether the new access policy sentence “In Department A, among members of assistant-manager rank or higher who are conducting Project A, allow access to the first resource information during the project period” is satisfied, in a state where it has been confirmed that the user of the first member account 501a is conducting Project A and is of assistant-manager rank in Department A. At this time, when it is confirmed that the user of the first member account is of assistant-manager rank in Department A and is conducting Project A, the access determination unit 505 may determine that the new access policy sentence is satisfied and that the first member account 501a can access the first resource information.

In another example, through the detail information included in the member attribute information 503a, the access determination unit 505 may compare whether the new access policy sentence “In Department A, among members of assistant-manager rank or higher who are conducting Project A, allow access to the first resource information between 13:00 and 17:00 during the project period” is satisfied, in a state where it has been confirmed that the user of the first member account 501a is conducting Project A and is of assistant-manager rank in Department A.

At this time, in a state where it has been confirmed that the user of the first member account is of assistant-manager rank in Department A and is conducting Project A and that the new access policy sentence is satisfied, if the access time of the first member account 501a accessing the first resource information is 17:30, the access determination unit 505 may determine that the first member account 501a cannot access the first resource information. In one embodiment, when the access determination unit 505 determines that the first member account 501a is an account not permitted to access the first resource information, the account access management unit 500 may output to the first member account 501a a sentence based on the new access policy information for the first resource information.

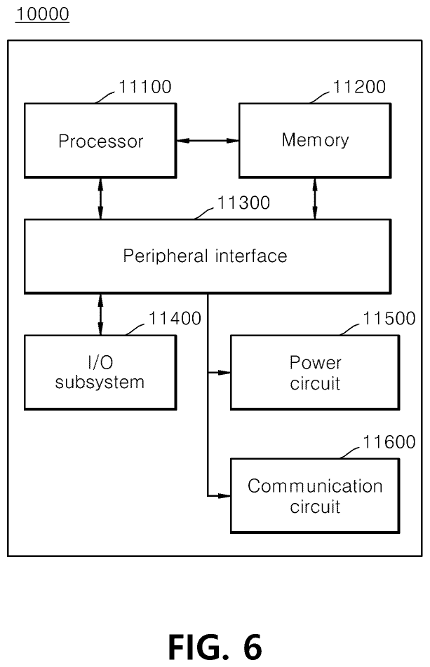

FIG. 6 is a drawing illustrating an example of an internal configuration of a computing device according to an embodiment of the present invention. FIG. 6 illustrates an example of an internal configuration of a computing device (10000) according to an embodiment of the present invention, and in the following description, redundant descriptions overlapping with the descriptions for FIGS. 1 to 5 are omitted.

As illustrated in FIG. 6, the computing device 10000 may include at least a processor (11100), a memory (11200), a peripheral interface (11300), an input/output (I/O) subsystem (11400), a power circuit (11500), and a communication circuit (11600). In this case, the computing device 10000 may correspond to a user terminal connected to a haptic (tactile) interface device (A) or to the above-described computing device (B). The memory 11200 may include, for example, high-speed random access memory, magnetic disk, SRAM, DRAM, ROM, flash memory, or nonvolatile memory. The memory 11200 may include software modules, instruction sets, or various other data necessary for the operation of the computing device 10000.

In this case, access by other components such as the processor 11100 or the peripheral interface 11300 to the memory 11200 may be controlled by the processor 11100. The peripheral interface 11300 may couple input and/or output peripherals of the computing device 10000 to the processor 11100 and the memory 11200. The processor 11100 may execute software modules or instruction sets stored in the memory 11200 to perform various functions for the computing device 10000 and to process data.

The I/O subsystem 11400 may couple various input/output peripherals to the peripheral interface 11300. For example, the I/O subsystem 11400 may include a controller for coupling peripherals such as a monitor, keyboard, mouse, or printer, or, as needed, a touch screen or sensors, to the peripheral interface 11300. In another aspect, the input/output peripherals may be coupled to the peripheral interface 11300 without passing through the I/O subsystem 11400.

The power circuit 11500 may supply power to all or some of the components of the device. For example, the power circuit 11500 may include a power management system, one or more power supplies such as a battery or AC, a charging system, a power failure detection circuit, a power converter or inverter, a power status indicator, or any other components for power generation, management, and distribution.

The communication circuit 11600 may enable communication with another computing device by using at least one external port. Alternatively, as needed as described above, the communication circuit 11600 may include an RF circuit and enable communication with another computing device by transmitting and receiving RF signals, also known as electromagnetic signals.

The embodiment of FIG. 6 is merely one example of the computing device 10000, and the computing device 10000 may omit some components illustrated in FIG. 6, may further include additional components not illustrated in FIG. 6, or may have a configuration or arrangement in which two or more components are combined. For example, a computing device for a communication terminal in a mobile environment may further include, in addition to the components illustrated in FIG. 6, a touch screen or sensors, and the communication circuit 11600 may include circuits for RF communication of various communication methods (WiFi, 3G, LTE, Bluetooth, NFC, Zigbee, etc.). Components that may be included in the computing device 10000 may be implemented by hardware, software, or a combination of hardware and software including one or more application-specific integrated circuits for signal processing or applications.

Methods according to the embodiments of the present invention may be implemented in the form of program instructions executable through various computing devices and recorded on a computer-readable medium. In particular, a program according to the present embodiment may be configured as a PC-based program or as an application dedicated to a mobile terminal. An application to which the present invention is applied may be installed in a user terminal through a file provided by a file distribution system. In one example, the file distribution system may include a file transmission unit (not shown) for transmitting the file in response to a request from a user terminal.

The devices described above may be implemented as hardware components, software components, and/or combinations of hardware and software components. For example, the devices and components described in the embodiments may be implemented using one or more general-purpose or special-purpose computers capable of executing and responding to instructions, such as a processor, controller, arithmetic logic unit (ALU), digital signal processor (DSP), microcomputer, field programmable gate array (FPGA), programmable logic unit (PLU), microprocessor, or any other device. The processing device may execute an operating system (OS) and one or more software applications running on the operating system. Further, in response to execution of software, the processing device may access, store, manipulate, process, and generate data. For ease of understanding, although in some cases a single processing device is described as being used, those skilled in the art will appreciate that the processing device may include a plurality of processing elements and/or a plurality of types of processing elements. For example, the processing device may include a plurality of processors or may include one processor and one controller. Other processing configurations, such as a parallel processor, are also possible.

Software may include a computer program, code, instructions, or any combination thereof, and may configure a processing device to operate as desired or may instruct the processing device, independently or collectively, to operate. Software and/or data may be embodied permanently or temporarily on any type of machine, component, physical device, virtual equipment, computer storage medium, or device, in order to be interpreted by the processing device or to provide instructions or data to the processing device. Software may be distributed across networked computing devices and may be stored or executed in a distributed manner. Software and data may be stored on one or more computer-readable recording media. Methods according to the embodiments may be implemented in the form of program instructions executable through various computer means and recorded on a computer-readable medium.

The computer-readable medium may include, alone or in combination, program instructions, data files, and data structures. The program instructions recorded on the medium may be specifically designed and configured for the embodiments or may be ones available to those skilled in the art of computer software. Examples of computer-readable recording media include magnetic media such as hard disks, floppy disks, and magnetic tapes, optical media such as CD-ROMs and DVDs, magneto-optical media such as floptical disks, and hardware devices specially configured to store and execute program instructions such as ROM, RAM, and flash memory. Examples of program instructions include machine code generated by a compiler as well as high-level language code that can be executed by a computer using an interpreter. The above-described hardware devices may be configured to operate as one or more software modules to perform operations of the embodiments, and vice versa.

Although the embodiments have been described with reference to limited embodiments and drawings as above, various modifications and variations are possible from the above description by those skilled in the art. For example, the described technologies may be performed in an order different from the described order and/or the components of the described systems, structures, devices, and circuits may be combined or combined in forms different from those described, or may be replaced or substituted by other components or equivalents, and still achieve appropriate results. Therefore, other implementations, other embodiments, and equivalents to the appended claims also fall within the scope of the appended claims.

What is claimed is:

1. A system for managing accounts based on access policies established through an ontology artificial intelligence algorithm, the system being implemented by a computing device including one or more processors and one or more memories storing instructions executable by the processors, the system comprising:
a work attribute information analysis unit configured to, when an update process for updating enterprise access policies is initiated through a plurality of pieces of work attribute information stored in a work database managed by an enterprise, analyze the plurality of pieces of work attribute information using a stored ontology artificial intelligence algorithm;
an access policy establishment unit configured to, upon completion of functions of the work attribute information analysis unit, update an existing access policy for resource information managed by the enterprise based on results of analyzing the plurality of pieces of work attribute information using the stored ontology artificial intelligence algorithm to establish a new access policy; and
an account access management unit configured to, when, in a state where the new access policy has been established, a first member account that accesses first resource information among a plurality of pieces of resource information stored in a resource database managed by the enterprise is identified, analyze member attribute information registered to the first member account and the new access policy to determine whether the first member account can access the first resource information and, based on a determination result, decide whether to permit the first member account to access the first resource information.

2. The system of claim 1, wherein the plurality of pieces of work attribute information includes intra-company bylaw information, email information of enterprise members, messenger information of enterprise members, and existing access policy information for enterprise resource information.

3. The system of claim 1, wherein the work attribute information analysis unit comprises:
a detail information identification unit configured to, when the update process is initiated, identify detail information included in each of the plurality of pieces of work attribute information stored in the work database;
a sentence confirmation unit configured to, upon completion of the function of the detail information identification unit, perform natural language processing on the identified detail information using the stored ontology artificial intelligence algorithm to confirm sentences corresponding to the detail information; and
a sentence structure identification unit configured to, upon completion of the function of the sentence confirmation unit, start a syntactic parsing process on the confirmed sentences using the stored ontology artificial intelligence algorithm to identify a sentence structure.

4. The system of claim 1, wherein the access policy establishment unit comprises:
a first semantic attribute-tag identification unit configured to, upon completion of functions of the work attribute information analysis unit, identify, for each keyword constituting an existing access policy sentence corresponding to existing access policy information among detail information included in the plurality of pieces of work attribute information, a first semantic attribute tag;
a second semantic attribute-tag identification unit configured to, while the first semantic attribute-tag identification unit operates, identify, for each keyword constituting a work attribute sentence corresponding to information other than the existing access policy information, a second semantic attribute tag; and
a non-identical tag identification unit configured to, upon completion of identification of the first and second semantic attribute tags, analyze the first and second semantic attribute tags using the stored ontology artificial intelligence algorithm to identify a second semantic attribute tag that does not match any first semantic attribute tag based on a preset RDF triple structure.

5. The system of claim 4, wherein the access policy establishment unit further comprises:
an existing access policy sentence update unit configured to, upon completion of the function of the non-identical tag identification unit, modify the existing access policy sentence based on a keyword to which a second semantic attribute tag different from the first semantic attribute tag is matched, and update the existing access policy sentence to a new access policy sentence based on a pattern value of the stored ontology artificial intelligence algorithm; and
a new access policy establishment unit configured to, upon completion of the function of the existing access policy sentence update unit, generate new access policy information based on the updated new access policy sentence and store the new access policy information in an access policy repository managed by the enterprise to complete establishment of the new access policy.

6. The system of claim 1, wherein the stored ontology artificial intelligence algorithm is an algorithm that learns pattern values derived by analyzing, on a session basis using timestamps, correlations among a plurality of pieces of work attribute information managed by other enterprises, relationship information among semantic attribute tags matched to keywords included in sentences corresponding to the plurality of pieces of work attribute information managed by other enterprises, existing access policy information for resource information managed by other enterprises, and new access policy information for the resource information managed by other enterprises.

7. The system of claim 1, wherein the account access management unit comprises: an
access-account detection unit configured to, in a state where the new access policy has been established, detect a first member account that accesses first resource information among a plurality of pieces of resource information stored in a resource database managed by the enterprise;
a member detail information identification unit configured to, upon completion of detection of the first member account that accesses the first resource information, identify detail information included in member attribute information registered to the first member account; and
an access determination unit configured to, upon completion of identification of the detail information included in the member attribute information, compare the new access policy information with the identified detail information and determine, based on a sentence defined by the new access policy information, whether the first member account can access the first resource information.

8. The system of claim 7, wherein, when the access determination unit determines that the first member account is not permitted to access the first resource information, the account access management unit outputs to the first member account a sentence based on the new access policy information for the first resource information.
